(19) United States
(12) Patent Application Publication
(10) Pub. No.: US 2011/0121135 A1
(43) Pub. Date: May 26, 2011

(54) GUARD FOR PROTECTING AN AIRCRAFT CARGO DOOR

(76) Inventor: Terry Michael MAGUIRE, Carringbah (AU)

(21) Appl. No.: 12/842,951

(22) Filed: Jul. 23, 2010

(30) Foreign Application Priority Data
Nov. 23, 2009 (AU) 2009905724

(51) Int. Cl. B64C 1/14

(52) U.S. Cl. 244/121

(57) ABSTRACT

This disclosure relates to a guard for protecting an aircraft cargo door during loading and unloading of cargo is provided, comprising a panel member adapted for covering at least a portion of an external skin of the cargo door, and one or more attachments for holding the panel member adjacent to the cargo door in use. Advantageously, the panel member is adapted to protect at least a portion of the external skin of the cargo door from being damaged during loading and unloading of cargo. In this respect, the panel member may be adapted to cover the portion of the external skin of the cargo door most prone to being damaged.

### CROSS-REFERENCE TO RELATED APPLICATION

This application claims the priority, under 35 U.S.C. §119, of co-pending Australian Provisional Patent Application Serial No. AU2009905724, filed Nov. 23, 2009, the entire disclosure of which is hereby incorporated herein by reference in its entirety.

### STATEMENT REGARDING FEDERALLY SPONSORED RESEARCH OR DEVELOPMENT

n/a

### FIELD OF THE INVENTION

The present invention relates to protection of aircraft cargo doors from damage during loading and unloading of cargo, and in particular to a guard removably attachable to cargo doors.

The invention has been developed primarily for use with aircraft cargo doors that are adapted to open inwardly with respect to the fuselage of the aircraft and will be described hereinafter with reference to this application. However, it will be appreciated that the invention is not limited to this particular field of use.

### BACKGROUND OF THE INVENTION

In a number of aircraft, the cargo doors are adapted to open inwardly with respect to the fuselage of the aircraft. This configuration exposes the external skin and the door seal of the cargo door to possible impact from any cargo during loading and unloading. Damage to the external skin of the cargo door or the door seal may prevent the aircraft from achieving a desired cabin pressure differential, thereby reducing the ability of the aircraft to fly at an efficient altitude.

Stringent safety procedures govern the airline industry and the severity of any damage caused to the aircraft must be investigated by the appropriate authorities to ensure airworthiness, which can lead to significant delays for passengers, disruption of flight schedules and ultimately considerable financial loss to the airline

Known measures for protecting the external skin and door seals of aircraft cargo doors from damage during loading and unloading of cargo include covers that can be deployed from within a stowed position within the cargo hold. This can be ineffective as covers stowed within the aircraft inherently add weight to the aircraft and take up valuable space in the hold.

The present invention seeks to provide a guard for protecting an aircraft cargo door during loading and unloading of cargo, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, a guard for protecting an aircraft cargo door during loading and unloading of cargo is provided, comprising:
a panel member adapted for covering at least a portion of an external skin of the cargo door; and
one or more attachments for holding the panel member adjacent to the cargo door in use.

Advantageously, the panel member is adapted to protect at least a portion of the external skin of the cargo door from being damaged during loading and unloading of cargo. In this respect, the panel member may be adapted to cover the portion of the external skin of the cargo door most prone to being damaged. For example, for a cargo door and external skin having a generally convex curvature and adapted to open inwardly with respect to the fuselage of the aircraft, the portion of the external skin most prone to being damaged would likely be a central portion of the cargo door in the open position, which would be at a lower level than either the end of the cargo door hingedly attached to the fuselage of the aircraft or the end located substantially opposite the hinged end of the cargo door, namely the free end.

Preferably, the panel member is adapted for covering the entire external skin of the cargo door.

Advantageously, the panel member is large enough to protect the entire external skin of the door from being damaged during loading and unloading of cargo.

Advantageously, the one or more attachments allow the panel member to be held adjacent to the cargo door to protect it from being damaged during unloading or loading of cargo. The one or more attachments may hold the panel member adjacent to the cargo door by attaching directly to points of attachment located on the cargo door, such as, for example, one or more lugs located around the periphery of the cargo door. In another example, the one or more attachments may hold the panel member adjacent to the cargo door by attaching directly to points of attachment located on the fuselage of the aircraft, such as, for example one or more cargo barrier anchor points located inside the aircraft. The one or more attachments may also hold the panel member adjacent to the cargo door by attaching directly to points of attachment located on the cargo door and on the fuselage of the aircraft. Preferably, the one or more attachments are adapted for removably attaching the panel member to the cargo door in use.

Advantageously, the panel member may be adapted for removable attachment to the cargo door such that when not in use, for example, when the loading or unloading of cargo is complete, the guard can be removed from the cargo door and stored at say, each respective bay at each airport.

Preferably, the panel member is adapted to cover the external skin and a door seal of the cargo door.

Advantageously, the panel member is adapted to protect both the external skin and the door seal of the cargo door from being damaged during loading and unloading of cargo.

Preferably, the one or more attachments are two or more attachments adapted for removably attaching the panel member to two or more corresponding lugs of the cargo door.

Preferably, the two or more attachments are four or more attachments adapted for removably attaching the panel member to four or more corresponding lugs of the cargo door.

Advantageously, utilizing the existing one or more lugs on the cargo door as points of attachment for removably attaching the panel member to the cargo door requires no modification in design of the cargo door to render the guard compatible for use with the cargo door.

Preferably, two of the four or more lugs are located at a free end of the cargo door and each of the remaining four or more lugs is located on either side of the cargo door.

Advantageously, the guard is removably attached to the cargo door along the free end and on both sides of the cargo door such that the guard is afforded zero degrees of freedom when attached.

Preferably, each of the four or more attachments is a tension member adapted to releasably engage a respective lug.

Advantageously, the length of the tension member can be varied to accommodate any variation in the position of the four or more lugs on the cargo door that may result from different aircraft configurations.

Preferably, each of the tension members is adapted to form a loop that can be looped over the respective lug.

Advantageously, forming the tension member into the loop allows the tension member to be attached to and removed from a respective lug simply and easily in one single action.

Preferably, each tension member further comprises a handle.

Advantageously, the handle is adapted to aid in looping each tension member over the respective lug.

Preferably, the panel member further comprises one or more grips adapted for use in manual transportation of the guard.

Advantageously, the grips afford a person transporting the guard to and from the aircraft a secure hold on the guard, which may be particularly beneficial in, for example, poor weather conditions such as high winds.

Preferably, each tension member is a shock cord.

Advantageously, each tension member is durable, waterproof and has good temperature resistance over a suitable operating range.

Advantageously, the elasticity of the shock cord allows the length of the tension members to be varied to accommodate any variation in the position of the four or more lugs on the cargo door that may be present due to different aircraft configuration.

Preferably, the panel member is constructed from a lightweight material.

Advantageously, the weight of a guard or a number of guards can be easily bore by one person.

Preferably, the panel member is constructed from a lightweight material that exhibits bulk material toughness, notched impact strength, wear and stress crack resistance.

Advantageously, the panel member can withstand any reasonable degree of impact experienced during loading and unloading of cargo.

Preferably, the lightweight material is an engineering polymer or engineering composite.

Preferably, the lightweight material is a thermoplastic polymer.

Preferably, the lightweight material is homopolymeric polypropylene with fine alpha crystalline structure.

Preferably, the lightweight material is SIMONA® PP-DWU AlphaPlus®.

Advantageously, SIMONA® PP-DWU AlphaPlus® exhibits bulk material toughness, notched impact strength, wear and stress crack resistance.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a fragmentary, side elevational view of an aircraft with a guard comprising a panel member removably attached to a cargo door in accordance with an exemplary embodiment of the present invention;

FIG. 2 is a plan view of the panel member of FIG. 1 comprising one or more attachments for removably attaching the panel member to a forward cargo door;

FIG. 3 is a plan view of the panel member of FIG. 1 comprising one or more attachments for removably attaching the panel member to an aft cargo door;

FIG. 4 is a side elevational view of the panel member of FIG. 1 showing a fold in the panel member;

FIG. 5 is a plan view of the forward cargo door of FIG. 2 showing four or more lugs adapted for releasably engaging the one or more attachments; and

FIG. 6 is a fragmentary, perspective view of one of the one or more attachments of FIG. 2 or FIG. 3 for removably attaching the panel member to the forward or aft cargo door, respectively.

### DETAILED DESCRIPTION OF SPECIFIC EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention.

While the specification concludes with claims defining the features of the invention that are regarded as novel, it is believed that the invention will be better understood from a consideration of the following description in conjunction with the drawing figures. The figures of the drawings are not drawn to scale. In the following description, like or the same reference numerals in different embodiments denote the same or similar features.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

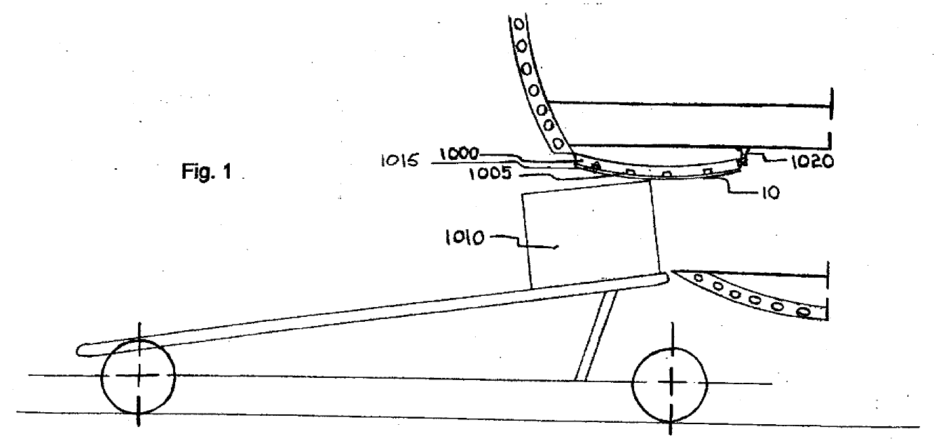

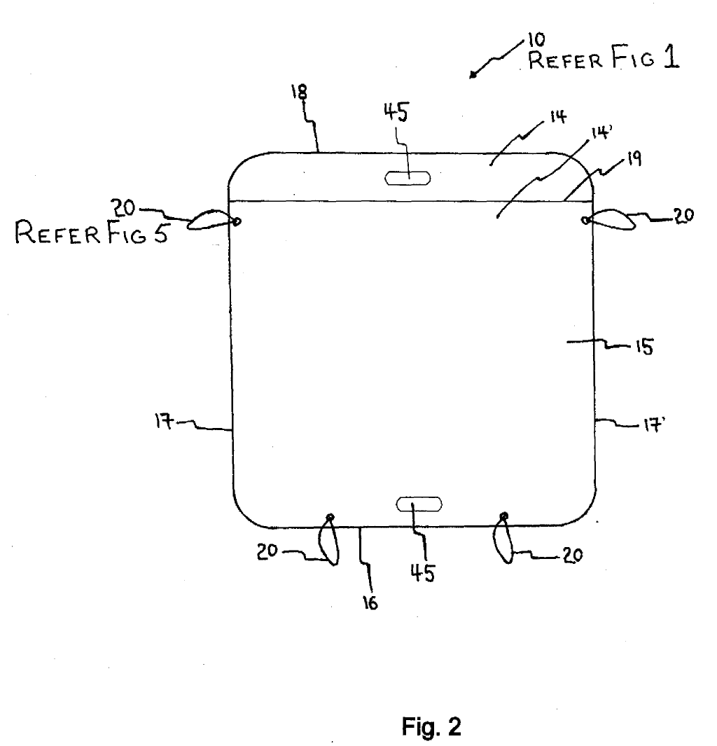

Described now are exemplary embodiments of the present invention. Referring now to the figures of the drawings in detail and first, particularly to FIGS. 1 and 2, there is shown, in a first exemplary embodiment of the present invention, a guard 10 for protecting an aircraft cargo door 1000 during loading and unloading of cargo 1010. The guard comprises: a panel member 15 adapted for covering at least a portion of an external skin 1005 of the cargo door 1000; and one or more attachments, generally indicated by the numeral 20, for holding the panel member 15 adjacent to the cargo door 1000 in use. In the exemplary embodiment, the panel member 15 is large enough to cover and thus protect the entire external skin 1005 of the cargo door 1000 from being damaged during loading and unloading of cargo 1000.

FIG. 1 shows the guard 10 removably attached to the cargo door 1000 of an aircraft during loading and unloading of cargo 1010. As shown in the figure, the cargo door 1000 of the aircraft, for example, a Boeing 737, is adapted to open inwardly with respect to the fuselage of the aircraft. This configuration exposes the external skin 1005 of the cargo door 1000 and the door seal (not shown) to possible impact during the loading or unloading of cargo 1010 having, for example, dimensions beyond a critical size.

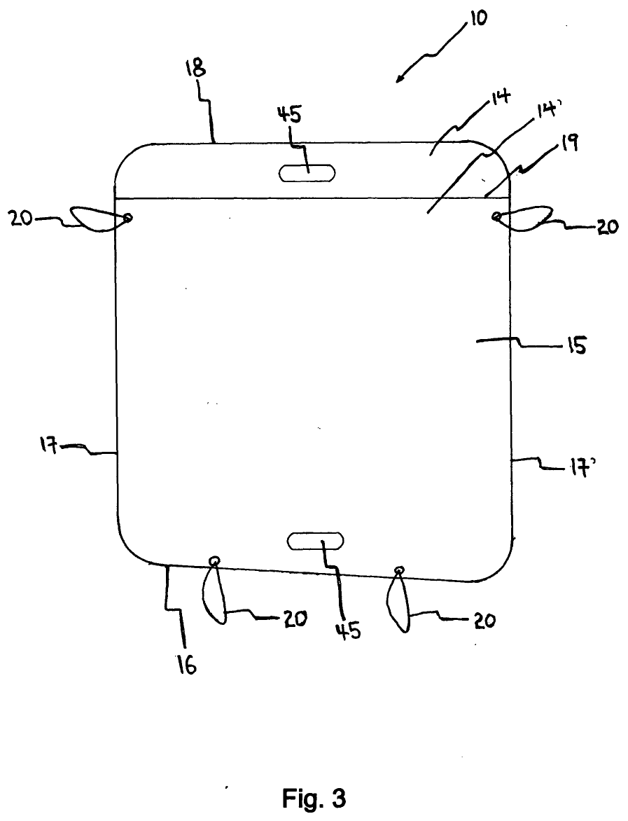

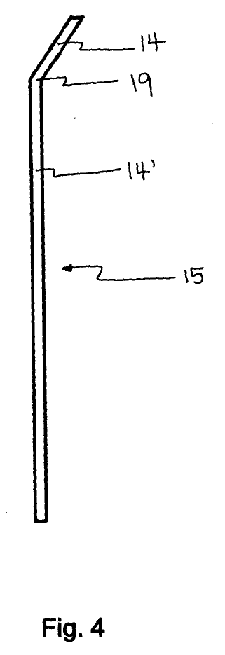

FIGS. 2 and 3 show a first embodiment of the guard 10 of the present invention comprising, a panel member 15 and one or more attachments 20 adapted for removably attaching the panel member 15 to the cargo door 1000 in use. In an exemplary embodiment, the panel member 15 has a plurality of straight-edges designated as straight-edges 16, 17, 17′ and 18. In one exemplary embodiment, the dimensions of straight-edges 16, 17, 17′ and 18 are adapted to compliment the dimensions of a forward cargo door of an aircraft, as shown in FIG. 2. In another embodiment, the dimensions of straight-edges 16, 17, 17′ and 18 are adapted to compliment the dimensions of an aft cargo door of an aircraft as shown in FIG. 3. It will be appreciated that the dimensions of straight-edges 16, 17, 17′ and 18 may be adapted to compliment the dimensions of the respective cargo door 1000 such that the panel member 15 covers at least a portion of the external skin 1005 of the cargo door 1000 in FIG. 1, and a door seal (not shown) of the cargo door 1000. It will also be appreciated that the panel member 15 may be adapted to compliment the external shape of the forward or aft cargo door 1000. In this embodiment, the panel member 15, having an upper side and an underside, is adapted to follow the generally convex curvature of the external skin 1005 of the cargo door 1000 such that the underside of the panel member 15 is held adjacent to the external skin 1005 of the cargo door 1000. Referring to FIGS. 2-4, in a further embodiment, the panel member 15 comprises a fold 19 offset from the straight edge 18. The fold 19 is adapted to divide the panel member into a smaller section 14 and a larger section 14′ such that the smaller section 14 is disposed at an angle with respect to the larger section 14′. It can be appreciated that the fold may be located at any suitable offset from straight edge 18; and the smaller section 14 may be disposed at any suitable angle with respect to the larger section 14′. In an exemplary embodiment, the fold is offset 15 centimeters from edge 18; and the smaller section 14 is disposed at an internal angle of 150° with respect to the larger section 14′.

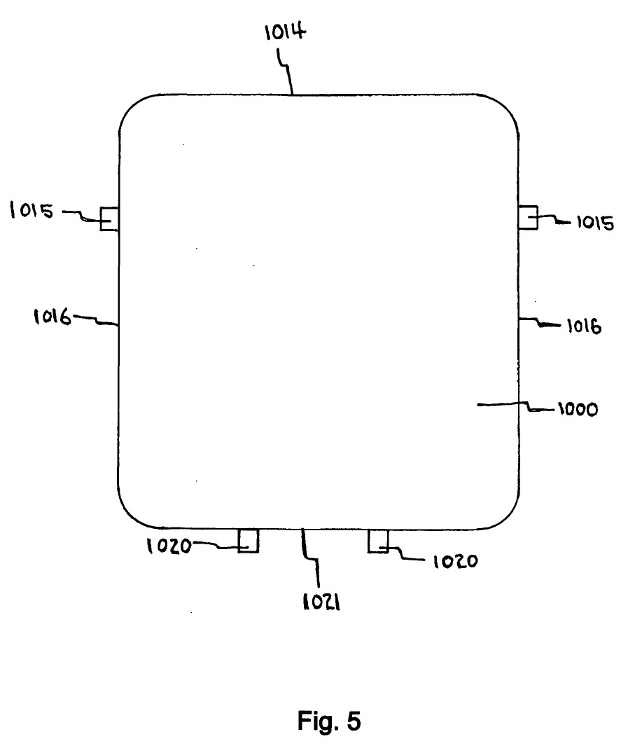

Referring to FIG. 5, it will be appreciated that the cargo door 1000 of the aircraft is hingedly attached to the fuselage of the aircraft at end 1014. The cargo door 1000 comprises a free end 1021 located substantially opposite the hinged end 1014 of the cargo door 1000 and sides, generally indicated by the numeral 1016. Referring to FIGS. 2 to 4, in an exemplary embodiment, the one or more attachments 20 are located around the periphery of the panel member 15 such that they can be removably attached to corresponding two or more lugs 1015 and 1020 of the cargo door 1000. However, it will be appreciated that the locations of the one or more attachments 20 of the panel member 15 are not limited to any specific position and that any suitable position is possible within the scope of the present invention. It will be appreciated that the two or more lugs of the cargo door 1000 are located around the periphery of the cargo door 1000. The two or more lugs may be, for example, two or more door stops or door pins adapted to engage with or be received in a corresponding housing located within the door frame (not shown) in the aircraft fuselage when the cargo door 1000 is secured in the closed position. It will also be appreciated that the cargo door 100 may comprise any number of lugs adapted for securing the cargo door 1000. For example, the forward and aft cargo doors of the Boeing 737 may comprise up to eight or more lugs located around the periphery of the cargo door.

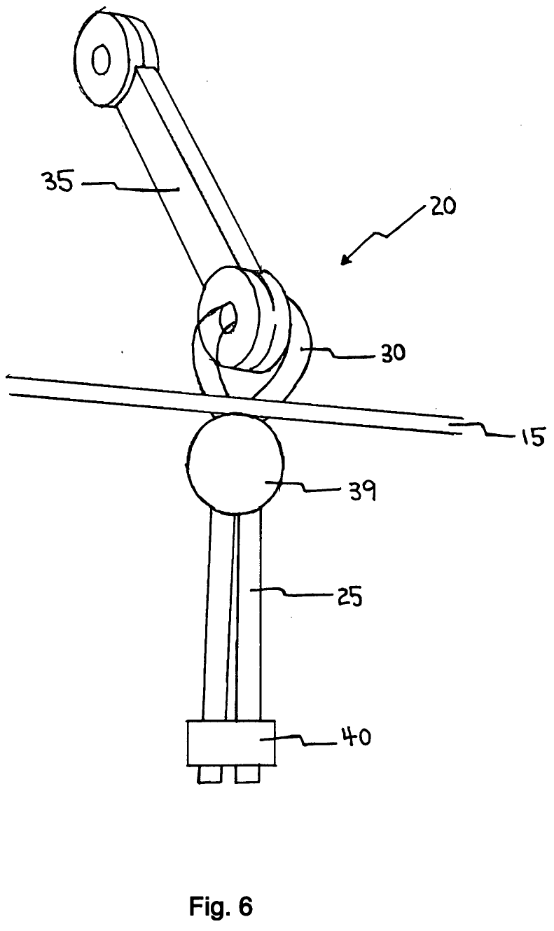

In an exemplary embodiment, the one or more attachments 20 of the panel member 15 are two or more attachments 20 adapted for removably attaching the panel member 15 to two or more corresponding lugs of the cargo door 1000. In this embodiment, the two or more attachments 20 are four or more attachments 20 adapted for removably attaching the panel member 15 to four or more corresponding lugs of the cargo door 1000. Two of the four or more corresponding lugs chosen as points of attachment are designated as 1020 and are located at the free end 1021 of the cargo door 1000. Each of the remaining four or more lugs are designated as 1015 and are located on either side 1016 of the cargo door 1000. FIG. 6 shows an exemplary embodiment of one of the one or more attachments 20. In this embodiment, the one or more attachments 20 are tension members 25 adapted to releasably engage a respective lug of the cargo door 1000. It will be appreciated by persons skilled in the art that the one or more attachments 20 are not limited to tension members 25 as shown in FIG. 6 but may include any one of a number of attachment devices or means, including but not limited to any one or more of the following: a bracket, a clip, a cable, a hoop. In this exemplary embodiment, each tension member 25 is adapted to locate within a corresponding hole within the panel member 15 such that, at the upper side of the panel member 15, the tension member 25 is adapted to form a loop 30 that can be looped over a respective lug, and at the underside of the panel member 15, the tension member 25 comprises a retaining member 40. In an exemplary embodiment, each tension member 25 further comprises a cushioning member 39 located between the retaining member 40 and the underside of the panel member 15. It will be appreciated by persons skilled in the art that the retaining member 40 may take the form of any one of the following retaining devices or means, including but not limited to any one of the following: a swage, a band, and a buckle. In another exemplary embodiment, each tension member 25 further comprises a handle 35. In the exemplary embodiment, the handle 35 is ergonomically shaped, for example, dog-bone shaped. However, it will be appreciated by persons skilled in the art that the shape of the handle 35 is not limited to the dog-bone shape and that any suitable shape is possible within the scope of the present invention.

Referring once again to FIGS. 2 and 3, the panel member 15 further comprises one or more grips 45 adapted for use in manual transportation of the guard 10. In an exemplary embodiment, the one or more grips 45 are one or more slots located in the panel member 15. However, it will be appreciated by persons skilled in the art that the one or more grips 45 are not limited to slots and that any suitable grip is possible within the scope of the present invention.

In another exemplary embodiment, the panel member 15 is constructed from a lightweight material to enable, for example, a single person to removably attach the panel member 15 to the cargo door 1000 without assistance. More particularly, the panel member 15 is constructed from a lightweight material that exhibits bulk material toughness, notched impact strength, and wear and stress crack resistance. It will be appreciated by persons skilled in the art that the lightweight material may be any one of a number of suitable lightweight materials, including but not limited to one or more: engineering polymers or engineering composites. In particular, the lightweight material is a thermoplastic polymer. It will be appreciated by persons skilled in the art that the thermoplastic polymer may be any one of a number of suitable thermoplastic polymers, including but not limited to any one or more of the following: polypropylene, high density polyethylene, and polyetheretherketone. In an exemplary embodiment, the thermoplastic polymer is a homopolymeric polypropylene with a fine alpha crystalline structure, such as the lightweight material SIMONA® PP-DWU AlphaPlus®.

In an exemplary embodiment, each tension member 25 is fabricated from an elasticised material to enable the loop 30 of the tension member 25 to be looped over the respective lug of the cargo door 1000. In particular, the elasticised material is shock cord. However, it will be appreciated by persons skilled in the art that the elasticised material of the tension member 25 is not limited to shock cord and that any suitable elasticized material is possible within the scope of the present invention.

In use, the guard 10 functions to protect the external skin 1005 of the cargo door 1000 from being damaged during loading and unloading of cargo 1010 from the aircraft (as shown in FIG. 1).

Referring to FIGS. 2 and 3, in an exemplary embodiment, the complementary dimensions of straight-edges 16, 17, 17′ and 18 of the panel member 15 allow the panel member 15 to overlay the corresponding forward or aft cargo doors 1000 of an aircraft such as the Boeing 737, such that the external skin 1005 of the cargo door 1000 and the door seal (not shown) located around the periphery of the cargo door 1000 are protected during loading and unloading of cargo. For example, the panel member 15 with dimensions as shown in FIG. 2 will overlay the forward cargo door and corresponding door seal, and the panel member 15 with dimensions as shown in FIG. 3 will overlay the aft cargo door and corresponding door seal. As shown in FIGS. 2 to 4, the fold 19 alters the geometry of the panel member 15 such that the area moment of inertia of the panel member 15 is increased. This reduces the deflection of the panel member 15 under its own weight, allowing the panel member 15 to overlay the cargo door 1000 closely.

Further shown in FIGS. 2, 3 and 5, attachments 20 allow the panel member 15 to be removably attached to the cargo door 1000 by attaching to corresponding lugs 1015 or 1020 of the cargo door 1000. Each of the attachments 20 is adapted to releasably engage a respective lug 1015 or 1020.

Referring to FIG. 6, in an exemplary embodiment, the loop 30 allows the tension member 25 to be looped over the respective lug 1015 or 1020. The retaining member 40 is adapted to retain the loop 30 in the tension member 25 and is further adapted to prevent the tension member 25 from being pulled through the hole in the panel member 15. The cushioning member 39 is adapted to prevent the retaining member 40 from, for example, damaging the underside of the panel member 15.

Referring to FIGS. 2 and 3, the one or more grips 45 located in the panel member 15 are adapted to enable, for example, a single person to removably attach the panel member 15 to the cargo door 1000. It will also be appreciated by persons skilled in the art that the one or more grips 45 will also enable a single person to transport the guard 10 from, for example, each respective bay at each airport, to the aircraft. In an exemplary embodiment, the one or grips 45 in the panel member 15 are slots, such that in use, one or more guards 10 may be easily transported by a single person.

A first advantage of at least some of the above embodiments is that the guard 10 offers the possibility to reduce aircraft ground time due to a lowering of the probability of inflicting damage to the cargo doors 1000 and door seals of the aircraft. In particular, the panel member 15 is adapted to protect at least a portion of the external skin 1005 of the cargo door 1000 from being damaged during loading and unloading of cargo 1010. In this respect, the panel member 15 may be adapted to cover the portion of the external skin 1005 of the cargo door 1000 having a generally convex curvature and adapted to open inwardly with respect to the fuselage of the aircraft most prone to being damaged. For example, for a cargo door 1000 and external skin 1005 having a generally convex curvature and adapted to open inwardly with respect to the fuselage of the aircraft, the most prone portion of the external skin 1005 if the cargo door 1000 may be a central portion of the cargo door 1000 as this would likely be at a lower level than either the end 1014 of the cargo door 1000 hingedly attached to the fuselage of the aircraft or the free end 1021 of the cargo door 1000 when the cargo door 1000 is in the open position. More advantageously, the panel member 15 will be large enough for covering and thus protecting the entire external skin 1005 of the cargo door 1000 during loading and unloading of cargo 1010. Advantageously, the panel member 15 is adapted to protect both the external skin 1005 and the door seal (not shown) of the cargo door 1000 from being damaged during loading and unloading of cargo 1010. This reduces the on ground repair time required in the event that the external skin 1005 and/or the door seal (not shown) of the cargo door is damaged during loading and unloading of cargo.

A second advantage of at least some of the above embodiments is that the guard 10 is simple, user friendly and convenient to use. The one or more attachments 20 allow the panel member 15 to be removably attached to the cargo door 1000 such that the guard 10 can be removed and stored at, for example, each respective bay at each airport. Advantageously, utilizing the existing one or more lugs on the cargo door 1000 as points of attachment for removably attaching the panel member 15 to the cargo door 1000 requires no modification in the design of the cargo door 1000 to render the guard 10 compatible for use with the cargo door 1000. Additionally, the length of the tension member 25 can be varied to accommodate any variation in the position of the four or more lugs 1015 and 1020 on the cargo door 1000, as may be realized due to different aircraft configurations. Advantageously, the elasticity of the shock cord further allows the length of the tension members 25 to be varied to accommodate any variation in the position of the four or more lugs 1015 and 1020 on the cargo door 1000. Furthermore, forming the tension member 25 into a loop 30 allows the tension member 25 to be attached to and removed from a respective lug 1015 or 1020 simply and easily in one single action. Advantageously, the handle 35 is adapted to aid in looping each tension member 25 over the respective lug 1015 or 1020. Additionally, the one or more grips 45 afford a person transporting the guard 10 to and from the aircraft a secure hold on the guard 10, which may be particularly beneficial in, for example, poor weather conditions such as in high winds. Advantageously, the weight of one guard 10 or several guards 10 may be easily bore by one person.

A third advantage of at least some of the above embodiments is that when the guard 10 is removably attached to the cargo door 1000 along the free end and on both sides of the cargo door 1000, the elasticity of the one or more tension members 25 ensures that the guard 10 has limited movement.

A fourth advantage of at least some of the above embodiments is that the guard 10 may be used in all weather conditions and is durable. Each tension member 25 is durable, waterproof and has good temperature resistance over a suitable operating range. Advantageously, the material of the panel member 15, SIMONA® PP-DWU AlphaPlus®, exhibits bulk material toughness, notched impact strength, wear and stress crack resistance such that the panel member 15 has the potential to withstand any reasonable degree of impact experienced during loading and unloading of cargo 1010.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In describing an exemplary embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

Thus, while there has been described what are believed to be various exemplary embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks.

Although the invention has been described with reference to specific examples, it will be appreciated by those skilled in the art that the invention may be embodied in many other forms.

It is apparent from the above, that the arrangements described are applicable to the airline industries.

1. A guard for protecting an aircraft cargo door during loading and unloading of cargo, comprising:
a panel member adapted for covering at least a portion of an external skin of the cargo door; and
one or more attachments for holding the panel member adjacent to the cargo door in use.

2. A guard as defined in claim 1, wherein the panel member is adapted for covering the entire external skin of the cargo door.

3. A guard as defined in claim 1, wherein the one or more attachments are adapted for removably attaching the panel member to the cargo door in use.

4. A guard as defined in claim 1, wherein the panel member is adapted to cover the external skin and a door seal of the cargo door.

5. A guard as defined in claim 1, wherein the one or more attachments are two or more attachments adapted for removably attaching the panel member to two or more corresponding lugs of the cargo door.

6. A guard as defined in claim 5, wherein the two or more attachments are four or more attachments adapted for removably attaching the panel member to four or more corresponding lugs of the cargo door.

7. A guard as defined in claim 6, wherein two of the four or more lugs are located at a free end of the cargo door and each of the remaining four or more lugs is located on either side of the cargo door.

8. A guard as defined in claim 6, wherein each of the four or more attachments is a tension member adapted to releasably engage a respective lug.

9. A guard as defined in claim 8, wherein each of the tension members is adapted to form a loop that can be looped over the respective lug.

10. A guard as defined in claim 9, wherein each tension member further comprises a handle.

11. A guard as defined in claim 1, wherein the panel member further comprises one or more grips adapted for use in manual transportation of the guard.

12. A guard as defined in claim 8, wherein each tension member is a shock cord.

13. (canceled)

14. A guard as defined in claim 1, wherein the panel member is constructed from a lightweight material that exhibits bulk material toughness, notched impact strength, and wear and stress crack resistance.

15. A guard as defined in claim 14, wherein the lightweight material is an engineering polymer or engineering composite.

16. A guard as defined in claim 15, wherein the lightweight material is selected from at least one of:
a thermoplastic polymer;
homopolymeric polypropylene with fine alpha crystalline structure; and
SIMONA® PP-DWU AlphaPlus®.

17. (canceled)

18. (canceled)

19. (canceled)

20. An aircraft cargo door guard for protecting an aircraft cargo door during loading and unloading of cargo, the aircraft door having an external skin, a door seal, and lugs, the aircraft cargo door guard comprising:
a panel member shaped to substantially cover an entirety of an external skin and a door seal of an aircraft cargo door, the panel member defining at least one grip opening shaped to receive a portion of a user's hand and being of a lightweight material selected from at least one of the group consisting of an engineering polymer, an engineering composite, a thermoplastic polymer, homopolymeric polypropylene with fine alpha crystalline structure, and SIMONA® PP-DWU AlphaPlus®; and
a set of at least two tension members operable to removably secure the panel member to respective ones of the cargo door lugs.

21. The door guard according to claim 20, wherein the cargo door has a free end and at least four lugs, and two of the lugs are located at the free end.
